(19) United States
(12) Patent Application Publication
(10) Pub. No.: US 2025/0381578 A1
(43) Pub. Date: Dec. 18, 2025

(54) Inflatable Drive Through Booth

(71) Applicant: Thomas Williams, Montgomery, TX (US)

(72) Inventor: Thomas Williams, Montgomery, TX (US)

(21) Appl. No.: 19/235,926

(22) Filed: Jun. 12, 2025

Related U.S. Application Data
(60) Provisional application No. 63/659,973, filed on Jun. 14, 2024.

(51) Int. Cl. B05B 16/80; B05B 16/40; E04H 15/20

(52) U.S. Cl. CPC B05B 16/80; B05B 16/40; E04H 15/20; E04H 2015/201

(57) ABSTRACT

The present invention relates to an inflatable drive paint through booth having positive pressure environment. The inflatable booth is portable and may be easily set up and taken down. The positive pressure allows for the quick and efficient removal of paint fumes and ensures that dirt and debris are not brought into the booth through the air when the personnel enter and leave the booth.

### CROSS REFERENCE TO RELATED APPLICATION

This application claims priority to U.S. Application No. 63/659,973 filed on Jun. 14, 2024, the disclosure of which is incorporated herein by reference for all purposes.

### FIELD OF THE INVENTION

The present invention relates to an inflatable drive through booth in which a positive pressure environment is created. More particularly, the present invention relates to an inflatable drive through booth for use in applying paint to a vehicle.

### BACKGROUND OF THE INVENTION

Inflatable booths and tunnels have been used for a multitude of purposes. U.S. Pat. Nos. 9,878,342 and 10,766,049, both of which are incorporated herein by reference for all purpose disclose inflatable drive in booths for applying paint to a vehicle. U.S. Pat. No. 10,717,103, incorporated herein by reference for all purposes, discloses an inflatable booth used for spraying bed liner into a truck bed. U.S. Pat. No. 11,560,730, incorporated herein by reference for all purposes, discloses an inflatable booth used in detecting dents in the body of a vehicle. Each of these prior art inflatable booths allows for a vehicle to be driven partially or completely through an inflatable structure.

### SUMMARY OF THE INVENTION

In one aspect, the present invention relates to an inflatable drive through booth.

In another aspect, the present invention relates to an inflatable drive through booth having a positive pressure environment. The positive pressure allows for the quick and efficient removal of paint fumes and ensures that dirt and debris are not brought into the booth through the air when the personnel enter and leave the booth.

These and further features and advantages of the present invention will become apparent from the following detailed description, wherein reference is made to the figures in the accompanying drawings.

### BRIEF DESCRIPTION OF THE DRAWINGS

FIG. 1 is a perspective view of one embodiment of the booth of the present invention.

FIG. 2 is another perspective view of the booth of FIG. 1.

FIG. 3 is a view of the interior of the booth of FIG. 1.

FIG. 4 is another view of the interior of the booth of FIG. 1.

FIG. 5 is yet another view of the interior of the booth of FIG. 1.

### DETAILED DESCRIPTION OF PREFERRED EMBODIMENTS

Embodiments of the invention are described more fully hereafter with reference to the accompanying drawings. Elements that are identified using the same or similar reference characters refer to the same or similar elements which perform the same functions across various embodiments. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

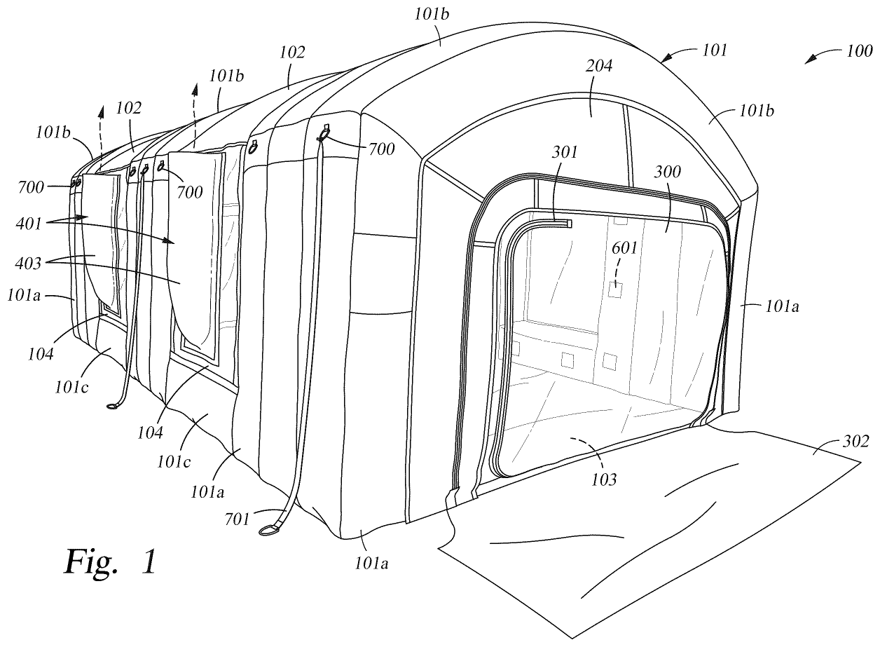

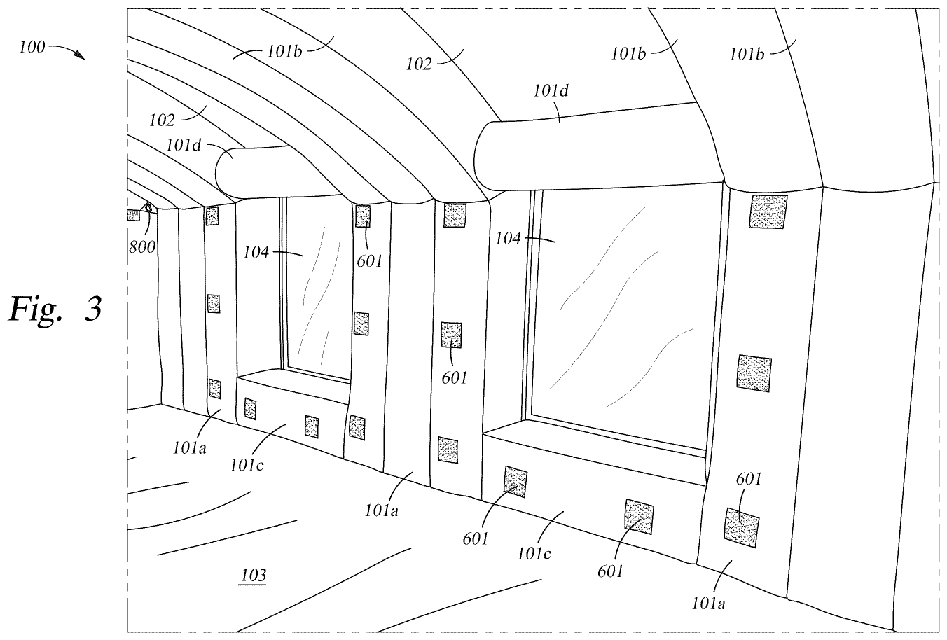

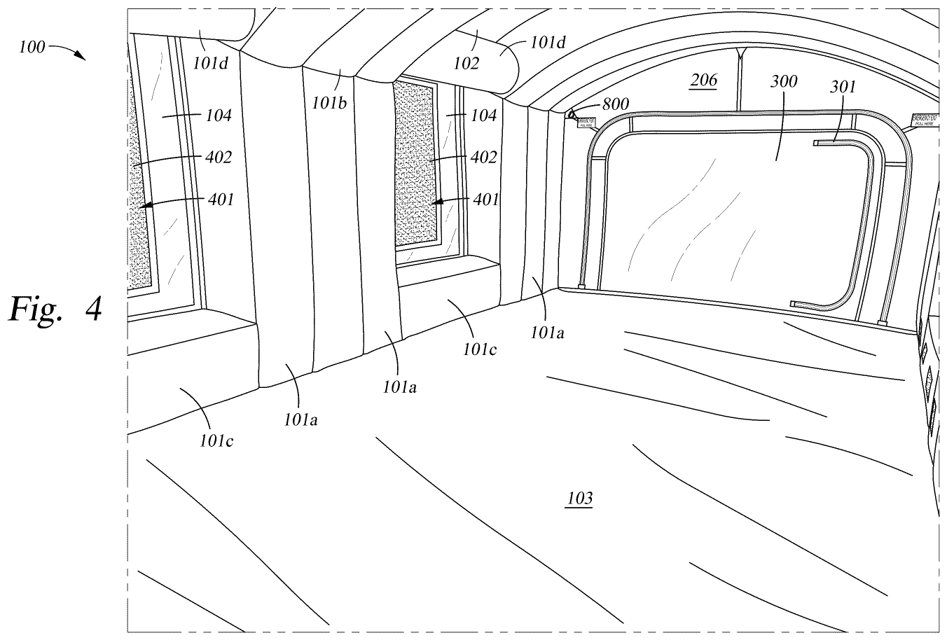

Turning to FIGS. 1-5, there is shown the positive pressure booth 100 of the present invention. In one embodiment booth 100 comprises an inflatable framework 101, a roof 102, a floor 103, and a plurality of wall sections 104. Inflatable framework 101 provides structure to booth 100. Inflatable framework 101 allows booth 100 to be portable and easy to set-up. Inflatable framework 101 comprises a plurality of vertical supports 101a and horizontal beams 101b. Inflatable framework 101 can further comprise one or more base supports 101c positioned below wall sections 104, and roof supports 101d positioned above wall sections 104. Roof 102 can be connected at the top portion of inflatable frame 101. If desired, roof 102 can comprise a translucent material that allows natural light to enter booth 100. Floor 103 is connected at the bottom of inflatable frame 101 and is preferably made of a durable plastic sheeting material including, but not limited to, high-density polyethylene. Wall sections 104 are preferably transparent and serve as windows.

FIG. 1 shows wall 204 comprising an entry port 300. Entry port 300 can be a resealable opening sufficiently large for any medical or storage equipment desired. Port 300 can have a smaller access opening in the form of resealable slit 301. Slit 301 can be in a variety of shapes, including but not limited to a C-shape, T-shape, or L-shape. Slit 301 is resealable and can be formed of a zipper fastener, hook and loop fabric, or other resealable means. In a preferred embodiment, slit 301 is formed of a zipper fastener. Entry port 300 may include mat 302 made of a durable sheet material such as plastic or fabric placed directly below entry port 300. Mat 302 may also be placed such that it extends into the interior of booth 100. It will be appreciated that wall 206 also includes its own entry port 300 and slit 301.

Booth 100 may also include exhaust panels 401 mounted in certain wall sections 104. Each exhaust panel can comprise a replaceable filter 402 and a flexible guide layer 403 for directing air in a desired direction. As seen in FIG. 1, guide layer 403 is open at the top to direct air upwards.

Inflatable framework 101 comprises a plurality of air vents 601. Air vents 601 can be openings that allow air to flow from framework 101 into the interior of booth 100. As such, air vents 601 allow the air that is pumped in to inflate frame 101 to enter the interior of booth 100 and create a positive pressure environment relative to that outside of booth 100. In a preferred embodiment, air vents 601 include filters which can capture and contain chemical and dust particulates such that they do not enter the interior of booth 100. The filters are preferably removable for easier cleaning or replacement. To ensure that the booth stays at a positive pressure relative to the area outside the booth, the air is driven through exhaust panels and filters only by the relative pressure from within the booth. In other words, the air being blown in through vents 601 drives the air in the booth through the exhaust panels and filters. There are no external suction devices, fans, or the like which pull air out of the booth.

In a preferred embodiment of the present invention, all air vents 601 are positioned on one side of the inflatable framework 101. This directs the air in a single direction, toward the exhaust panels 401 and filters 402 across from air vents 601. Unlike some prior art inflatable booth designs, the present invention does not include air vents 601 in any of the horizontal beams 101b.

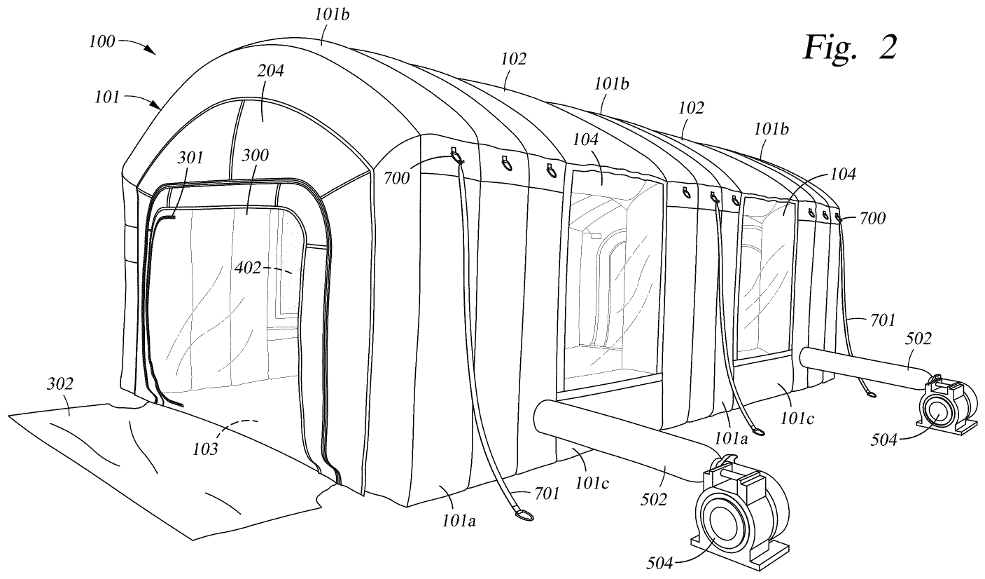

As seen in FIG. 2, air inlet 502 allows air pumped by pumps 504 to enter and fill inflatable frame 101. In a preferred embodiment, air inlets 502 are positioned on the side of booth 100 having the air vents 601, opposite the side in which the exhaust panels 401 are positioned. Air pumps 504 must be sized according to the characteristics of booth 100. For example, if booth 100 is 16′×16′×9′, with twelve air vents 601 each around 3″×3″, then one or more air pumps capable of pushing around 5,000 cfm of air would be sufficient to inflate booth 100 without damaging it and maintain sufficient air turnover within the interior of the booth. In a preferred embodiment, air the within interior space should turn completely at least once every twenty minutes.

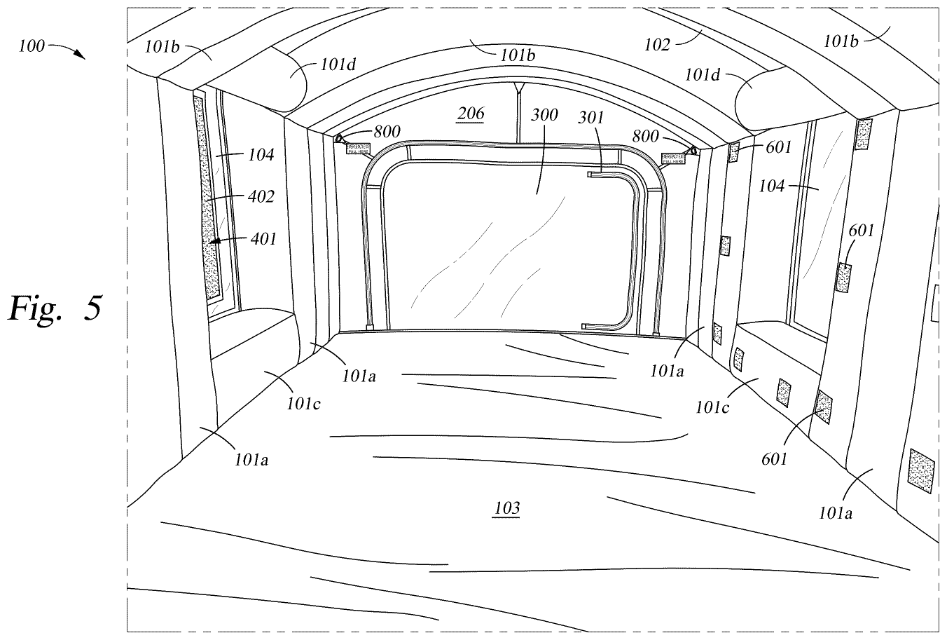

Loops 700 and straps 701 may be positioned along the outside of the booth. The loops 700 and straps 701 may be used if needed to further secure the booth should high winds or the like be a concern. One or more emergency exit loops 800 may be secured to either or both walls 204/206 (see FIG. 5). When pulled, an emergency exit loop immediately disconnects all or part of the respective wall to allow for a quick escape from the booth. In case of an emergency, this is faster than trying to open slit 301.

In use, a person can drive a vehicle to be painted into booth 100 through one of ports 300. Air pumps 504 will drive air into booth 100 through vents 601. The flowing air will carry any paint fumes out through filters 402 and exhaust panels 401. Flexible guides 403 will direct the fumes upward and away from anyone standing outside near the booth. The positive pressure will also keep dirt and debris from entering the booth. The inclusion of the air vents 601 along one side of booth 100 provides a straight flow line of air toward the exhausts. The positioning of the air vents also results in a shorter line of travel from the air vents to the exhausts than that compared to prior art booths. When the painting is completed, the vehicle can be driven through either port 300, as desired. The presence of ports 300 on both sides of the booth improves the flexibility of the booth. The vehicle being painted need not be driven back out of the same port 300 in which it was driven through, unless so desired. It will be appreciated that the vehicle in question may not be drivable at the time and thus, it can be towed into the booth via a first port 300, disconnected from the tow vehicle for painting, and then reconnected and towed out of the booth through the other port 300. Likewise, vehicle components (or other articles) may be carried into the booth for painting.

Although specific embodiments of the invention have been described herein in some detail, this has been done solely for the purposes of explaining the various aspects of the invention and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

1. An inflatable booth comprising:
an inflatable framework including inflatable vertical supports, inflatable horizontal beams;
a roof;
a plurality of wall sections; and
at least one inflation port for inflating said framework; and
one or more air vents in the inflatable vertical supports, said air vents allowing air to pass from an inside of said inflatable framework to an interior area of said booth to create a positive pressure within said inflatable booth.

2. The inflatable booth of claim 1, further comprising one or more inflatable base supports along the bottom of said wall sections.

3. The inflatable booth of claim 2, further comprising one or more air vents in the one or more inflatable base supports.

4. The inflatable booth of claim 1, wherein said roof is made of a translucent material.

5. The inflatable booth of claim 1, wherein said wall sections are made of a transparent material.

6. The inflatable booth of claim, further comprising one or more exhaust panels positioned in a wall section.

7. The inflatable booth of claim 6, wherein said exhaust panels comprise a flexible guide layer.

8. The inflatable booth of claim 1, wherein said one or more air vents have filters.
